(19) United States
(12) Patent Application Publication
(10) Pub. No.: US 2017/0081544 A1
(43) Pub. Date: Mar. 23, 2017

(54) CARPET COATING COMPOSITIONS

(71) Applicant: CELANESE INTERNATIONAL CORPORATION, Irving, TX (US)

(72) Inventors: Harmin MUELLER, Hofheim (DE); Daliah VOGT, Frankfurt am Main (DE); Paul SCOTT, Epsom (GB); Yi HAN, Guangzhou (CN); David LUNSFORD, Fountain Inn, SC (US); Alistair MCLENNAN, Koenigstein (DE)

(21) Appl. No.: 15/267,332

(22) Filed: Sep. 16, 2016

Related U.S. Application Data
(60) Provisional application No. 62/220,525, filed on Sep. 18, 2015.

(51) Int. Cl. C09D 129/04; D06N 7/00; C09D 7/12

(52) U.S. Cl. CPC C09D 129/04; C09D 7/1216; D06N 7/0005; C08K 3/26

(57) ABSTRACT

An aqueous carpet coating composition comprises: (A) at least one particulate filler material; and (B) a stabilized copolymer dispersion comprising: (a) a copolymer formed by emulsion polymerization of a monomer mixture comprising a vinyl ester of an alkanoic acid having 1 to 18 carbon atoms and 1 to 25 pphm of ethylene, wherein the copolymer comprises particles having a weight average particle size, d_{w}, of at least 200 nm as determined by Beckman Coulter LS 13320; (b) water; and (c) a stabilizing system comprising (i) 1 to 4 pphm of an emulsifier component consisting of at least one non-ionic surfactant and (ii) 0.5 to 4 pphm of at least one first polyvinyl alcohol component having a degree of hydrolysis greater than 92 mol %.

### CROSS REFERENCE TO RELATED APPLICATIONS

This application claims the benefit of the filing date of U.S. Provisional Application No. 62/220,525 filed Sep. 18, 2015, the entire contents of which are incorporated herein by reference.

### FIELD

The present development relates to carpet coating compositions and carpet products containing the same.

### BACKGROUND

Most conventional carpets comprise a primary backing with yarn tufts in the form of cut or uncut loops extending upwardly from this backing to form a pile surface. For tufted carpets, the yarn is inserted into a primary backing (frequently a woven or nonwoven substrate) by tufting needles and a pre-coat (i.e., a binder) is applied thereto.

Many residential and commercial carpets are also manufactured with a woven scrim (typically made from polypropylene), also referred to as a secondary backing, attached to the back of the carpet to provide dimensional stability. The scrim is attached to the precoated carpet backing with another binder formulation typically referred to as a skipcoat or adhesive layer. The adhesive layer (skipcoat) is applied on top of the already precoated carpet backside. The scrim is then applied into the adhesive layer of the carpet before the assembled carpet elements are sent to a drying oven. The purpose of the adhesive layer (skipcoat) is to provide a layer of material which will adhere the woven scrim/non woven secondary backing to the back of the carpet.

For both the precoat and the adhesive layer, the physical properties of the binder coating are important to its successful utilization in a carpet product. In this regard, there are a number of important requirements which must be met by such coatings. The coating must be capable of being applied to the carpet and dried using the processes and equipment conventionally employed in the carpet industry for latex, e.g. emulsion, coating. The binder composition must provide excellent adhesion to the pile fibers to secure them firmly in the backing. The coating will also typically have a high loading of fillers such as calcium carbonate, clay, aluminum trihydrate, barite, feldspar, cullet, fly ash and/or recycled carpet backing.

The binders in coating compositions for carpet materials are frequently emulsion polymers, i.e., latex dispersions, such as styrene-based emulsion copolymers like styrene-butadiene latex (SBL) materials or such as acrylic polymer latex dispersions. For example, vinyl ester copolymers can be used to provide carpet products which are desirably low in VOC (volatile organic compound) content and which do not contain potentially toxic materials such a 4-phenyl cyclohexene (4-PCH), 4-vinyl cyclohexene (4-VCH) and related compounds which can be found in styrene-butadiene based emulsion polymers.

Emulsion binders and carpet coating compositions based on vinyl ester/ethylene, e.g., vinyl acetate/ethylene (VAE) copolymers are disclosed, for example, in WO 2010/089142 and in U.S. Pat. Nos. 4,735,986; 5,026,765; 5,849,389; 6,359,076; 7,056,847; 7,582,699; 7,649,067 and in U.S. Patent Application Publication Nos. 2005/0287336 and 2014/0087120

Notwithstanding the availability of a variety of carpet coating compositions based on vinyl ester/ethylene copolymer binders, certain properties of these coating compositions would benefit from further advances. In particular, the carpet industry is always interested in maximizing throughput in the manufacturing process without compromising the properties of the final carpet. As a result, improved foaming behavior of the carpet coating composition and reduced drying time of the adhesive coating are crucial targets for the industry. Moreover, these must be achieved whilst retaining the delamination strength, high filler compatibility and excellent flow properties of the coating composition.

### SUMMARY

It has now been discovered that the goals of improved foaming behavior and faster drying can be achieved using certain vinyl ester/ethylene copolymer dispersions with a specific ethylene content and a stabilizer package comprising a specific combination of polyvinyl alcohols and nonionic surfactant.

The present invention is directed to carpet products comprising at least one flexible substrate and at least one coating or adhesive layer associated with the at least one flexible substrate. The coating or adhesive layer is formed from an aqueous coating composition comprising: (A) at least one particulate filler material; and (B) a stabilized copolymer dispersion.

The copolymer dispersion comprises: 1) a copolymer formed by emulsion polymerization of a monomer mixture comprising a vinyl ester of an alkanoic acid having from 1 to 18 carbon atoms and from 1 to 25 pphm of ethylene, water and a stabilizing system. Preferably, vinyl acetate is utilized. The copolymer comprises particles having a weight average particle size, d_{w}, of at least 200 nm as determined by Beckman Coulter LS 13320. Further, the copolymer dispersion preferably has desirable foam characteristics, and may require less than 300 seconds to achieve a foam density of 950±50 g/l.

The stabilizing system utilized contains from 1 to 4 pphm of an emulsifier component consisting of at least one non-ionic surfactant and from 0.5 to 4 pphm of at least one first polyvinyl alcohol component having a degree of hydrolysis greater than 92 mol %, preferably greater than 97 mol %. In one embodiment, the first polyvinyl alcohol component(s) may have a Höppler viscosity, as measured at 20° C. on a 4% by weight concentration aqueous solution, of less than 10 mPa-s. Optionally, the stabilizing system also includes up to 8 pphm of at least one second polyvinyl alcohol component having a degree of hydrolysis greater than 80 mol % and less than 90 mol %. In one embodiment, the second polyvinyl alcohol component(s) may have a Höppler viscosity, as measured at 20° C. on a 4% by weight concentration aqueous solution, from 2 to 60 mPa-s.

The carpet products herein will generally exhibit good drying characteristics due to water retention values of the aqueous coating composition. Preferably, the aqueous coating composition has a water retention value of greater than 150 g/m². The carpet products will also generally exhibit good wet delamination strengths of at least 11 N/5 cm.

### DETAILED DESCRIPTION

Aqueous carpet coating compositions of the present invention show improved drying times and improved foaming characteristics over prior art coating compositions, and include at least one particulate filler material and a stabilized vinyl acetate/ethylene (VAE) copolymer dispersion composition. The components and preparation of the aqueous carpet coating compositions are described in detail below.

### Copolymer Dispersion

The stabilized copolymer dispersion for use in the present invention includes a copolymer formed by emulsion polymerization of a monomer mixture comprising, as main monomers, at least one vinyl ester of an alkonoic acid having from 1 to 18 carbon atoms, and ethylene. Suitable vinyl esters include vinyl formate, vinyl propionate, vinyl butyrate, vinyl isobutyrate, vinyl benzoate, vinyl-2-ethyl-hexanoate, vinyl esters of an [alpha] -branched carboxylic acid having 5 to 11 carbon atoms in the acid moiety, e.g., Versatic™ acids, and the vinyl esters of pivalic, 2-ethylhexanoic, lauric, palmitic, myristic, and stearic acid. In one embodiment, the vinyl ester comprises vinyl acetate. Typically, the monomer mixture contains from 1 to 25 pphm (parts per hundred parts by weight of the total monomers) ethylene, preferably from 6 to 25 pphm ethylene, more preferably from 6 to 20 pphm ethylene, and most preferably from 6 to 14 pphm ethylene.

The monomer mixture may also comprise one or more non-functional main co-monomers. One type of such optional non-functional main co-monomer comprises one or more esters of ethylenically unsaturated mono-carboxylic acids or diesters of ethylenically unsaturated di-carboxylic acids. Particularly advantageous co-monomers of this type are the esters of alcohols having one to eighteen carbon atoms. Examples of such non-functional, main co-monomers include methyl methacrylate or acrylate, butyl methacrylate or acrylate, 2-ethylhexyl methacrylate or acrylate, dibutyl maleate and/or dioctyl maleate. Combinations of two or more of the foregoing optional non-functional main co-monomer types can be co-polymerized into the emulsion copolymer. If present, such non-functional main co-monomers can comprise up to about 40 wt % based on total main co-monomers in the copolymer. More preferably, such non-functional main co-monomers can comprise from about 5 wt to about 20 wt %, based on the total main co-monomers in the emulsion copolymer.

The vinyl ester/ethylene copolymer dispersion used in the coatings for the carpet products herein can also optionally contain relatively minor amounts of other types of co-monomers besides vinyl acetate, ethylene or other main co-monomer types. Such other optional co-monomers will frequently be those which contain one or more functional groups and can serve to provide or facilitate cross-linking between copolymer chains within the copolymer dispersion-containing aqueous composition upon the drying or curing of films and coatings formed from such compositions.

Such optionally present, functional co-monomers can include ethylenically unsaturated acids, e.g. mono- or di-carboxylic acids, sulfonic acids or phosphonic acids. In place of the free acids, it is also possible to use their salts, preferably alkali metal salts or ammonium salts. Examples of optional functional co-monomers of this type include acrylic acid, methacrylic acid, crotonic acid, maleic acid, fumaric acid, itaconic acid, vinylsulfonic acid, vinylphosphonic acid, styrenesulfonic acid, monoesters of maleic and/or fumaric acid, and of itaconic acid, with monohydric aliphatic saturated alcohols of chain length C₁-C₁₈, and also their alkali metal salts and ammonium salts, or (meth) acrylic esters of sulfoalkanols, an example being sodium 2-sulfoethyl methacrylate.

Other types of suitable optional functional co-monomers include ethylenically unsaturated co-monomers with at least one amide-, epoxy-, hydroxyl, trialkoxysilane- or carbonyl group. Particularly suitable are ethylenically unsaturated epoxide compounds, such as glycidyl methacrylate or glycidyl acrylate. Also suitable are hydroxyl compounds including methacrylic acid and acrylic acid C₁-C₉ hydroxyalkyl esters, such as n-hydroxyethyl, n-hydroxypropyl or n-hydroxybutyl acrylate and methacrylate. Other suitable functional co-monomers include compounds such as diacetone acrylamide and acetylacetoxyethyl acrylate and methacrylate; and amides of ethylenically unsaturated carboxylic acids, such as acrylamide or methacrylamide.

As noted, the emulsion copolymer used herein can optionally contain trialkoxysilane functional co-monomers. Alternatively, the emulsion copolymers used herein can be substantially free of silane-based co-monomers.

Optional functional co-monomers can be incorporated into the ethylene and vinyl ester of an alkonoic acid based copolymer used herein in amount of up to about 5 wt %, such as 0-2 wt %, based on total main co-monomers in the copolymer.

The emulsion copolymer can be formed within the copolymer dispersion using emulsion polymerization techniques described more fully hereinafter. Within the resultant dispersion, the copolymer is typically present as particles having a weight average particle size (d_{w}) of at least 200 nm, preferably from 200 to 2000 nm, more preferably 200 to 1500 nm, most preferably 200 to 1000 nm, as determined by laser diffraction using a Beckman Coulter LS 13320 particle size analyzer.

Depending upon co-monomer type, solubility and the monomer feeding techniques employed, the emulsion copolymer can be either homogeneous or heterogeneous in monomeric configuration and make-up. Homogeneous copolymers will have a single discreet glass transition temperature, T_{g}, as determined by differential scanning calorimetry techniques. Heterogeneous copolymers will exhibit two or more discreet glass transition temperatures and might lead to core shell particle morphologies. Whether homogeneous or heterogeneous, the emulsion copolymer used herein normally has a glass transition temperature, T_{g}, which ranges between about −20° C. and +35° C., more preferably between about −5° C. and about +20° C. As is known, the T_{g} of the polymer can be controlled, for example, by adjusting the ethylene content, i.e., generally the more ethylene present in the copolymer relative to other co-monomers, the lower the T_{g}.

The stabilizing system used in the preparation of the present copolymer dispersion comprises (i) from 1 to 4 pphm, for example from 1.5 to 3 pphm, such as from 1 to 3 pphm, of an emulsifier component consisting of at least one non-ionic surfactant, (ii) from 0.5 to 4 pphm, for example from 1 to 3 pphm, such as from 1 to 2 pphm, of at least one first polyvinyl alcohol component having a degree of hydrolysis greater than 92 mol %, and preferably greater than 97 mol %, and optionally (iii) 0 to 8 pphm, for example from 0 to 6 pphm, such as from 0 to 4 pphm, of at least one second polyvinyl alcohol component having a degree of hydrolysis greater than 80 mol % and less than 90 mol %, preferably from 87 to 89 mol %. In some embodiments, the at least one first polyvinyl alcohol component may have a Höppler viscosity, as measured at 20° C. on a 4% by weight concentration aqueous solution, of less than 10 mPa-s, such as from 1 to 8 mPa-s, and the optional at least one second polyvinyl alcohol component may have a Höppler viscosity, as measured at 20° C. on a 4% by weight concentration aqueous solution, of 2 to 60 mPa-s, such as from 2 to 40 mPa-s. In some embodiments, the total amount of polyvinyl alcohol in the stabilizing system is from 1 to 10 pphm, for example from 1 to 6 pphm, such as from 1 to 5 pphm Blends of two or more polyvinyl alcohols, such as blends of high and low molecular weight polyvinyl alcohols, can be used as one or both of the first and second polyvinyl alcohol components.

Examples of suitable non-ionic emulsifiers include acyl, alkyl, oleyl, and alkylaryl ethoxylates. These products are commercially available, for example, under the name Genapol®, Lutensol® or Emulan®. They include, for example, ethoxylated mono-, di-, and tri-alkylphenols (EO degree: 3 to 50, alkyl substituent radical: C₄ to C₁₂) and also ethoxylated fatty alcohols (EO degree: 3 to 80; alkyl radical: C₈ to C₃₆), especially C₁₂-C₁₄ fatty alcohol (3-40) ethoxylates, C₁₃-C₁₅ oxo-process alcohol (3-40) ethoxylates, C₁₆-C₁₈ fatty alcohol (11-80) ethoxylates, C₁₀ oxo-process alcohol (3-40) ethoxylates, C₁₃ oxo-process alcohol (3-40) ethoxylates, polyoxyethylenesorbitan monooleate with 20 ethylene oxide groups, copolymers of ethylene oxide and propylene oxide having a minimum ethylene oxide content of 10% by weight, and the polyethylene oxide (4-40) ethers of oleyl alcohol. Particularly suitable are the polyethylene oxide (4-40) ethers of fatty alcohols, more particularly of oleyl alcohol, stearyl alcohol or C₁₁ alkyl alcohols. Anionic emulsifiers are generally not included in the present copolymer dispersion since it is believed that they have a negative effect on wet mechanical properties of the carpet coating composition.

### Copolymer Dispersion Preparation

The copolymer dispersions comprising the vinyl ester/ethylene copolymers described herein can be prepared using emulsion polymerization procedures which result in the preparation of polymer dispersions in aqueous latex form. Such preparation of aqueous polymer dispersions of this type is well known and has already been described in numerous instances and is therefore known to the skilled artisan. Such procedures are described, for example, in U.S. Pat. No. 5,849,389, and in the Encyclopedia of Polymer Science and Engineering, Vol. 8, p. 659 ff (1987). The disclosures of both of these publications are incorporated herein by reference in their entirety.

The polymerization may be carried out in any manner known per se in one, two or more stages with different monomer combinations, giving polymer dispersions having particles with homogeneous or heterogeneous, e.g., core shell, morphology. Any reactor system, such as batch, semi-batch, loop, continuous, cascade, etc, may be employed. A preferred variant is a batch or semi-batch process in a stirred tank reactor

The polymerization temperature generally ranges from about 20° C. to about 150° C., more preferably from about 50° C. to about 120° C. The polymerization generally takes place under pressure if appropriate, preferably from about 2 to about 150 bar, more preferably from about 5 to about 100 bar.

In a typical polymerization procedure involving vinyl acetate/ethylene copolymer dispersions, the vinyl acetate, ethylene, and other co-monomers can be polymerized in an aqueous medium under pressures up to about 120 bar in the presence of one or more initiators and at least one emulsifying agent, optionally along with protective colloids like PVOH. The aqueous reaction mixture in the polymerization vessel can be maintained by a suitable buffering agent at a pH of about 2 to about 7.

The manner of combining the several polymerization ingredients, i.e., emulsifiers, co-monomers, catalyst system components, etc., can vary widely. Generally an aqueous medium containing at least some of the emulsifier(s) can be initially formed in the polymerization vessel with the various other polymerization ingredients being added to the vessel thereafter.

Co-monomers can be added to the polymerization vessel continuously, incrementally or as a single charge addition of the entire amounts of co-monomers to be used. Co-monomers can be employed as pure monomers or can be used in the form of a pre-mixed emulsion. Ethylene as a co-monomer can be pumped into the polymerization vessel and maintained under appropriate pressure therein.

As noted, the polymerization of the ethylenically unsaturated monomers will generally take place in the presence of at least one initiator for the free-radical polymerization of these co-monomers. Suitable initiators for the free-radical polymerization, for initiating and continuing the polymerization during the preparation of the dispersions, include all known initiators which are capable of initiating a free-radical, aqueous polymerization in heterophase systems. These initiators may be peroxides, such as alkali metal and/or ammonium peroxodisulfates, or azo compounds, more particularly water-soluble azo compounds.

As polymerization initiators, it is also possible to use what are called redox initiators. Examples thereof are tert-butyl hydroperoxide and/or hydrogen peroxide in combination with reducing agents, such as with sulfur compounds, an example being the sodium salt of hydroxymethanesulfinic acid, Bruggolit FF6 and FF7, Rongalit C, sodium sulfite, sodium disulfite, sodium thiosulfate, and acetone-bisulfite adduct, or with ascorbic acid, sodium erythobate, or with reducing sugars.

The amount of the initiators or initiator combinations used in the process varies within the usual limits for aqueous polymerizations in heterophase systems. In general the amount of initiator used will not exceed 5% by weight, based on the total amount of the co-monomers to be polymerized. The amount of initiators used, based on the total amount of the co-monomers to be polymerized, is preferably 0.05% to 2.0% by weight.

In this context, it is possible for the total amount of initiator to be included in the initial charge to the reactor at the beginning of the polymerization. More preferably, however, a portion of the initiator is included in the initial charge, and the remainder is added after the polymerization has been initiated, in one or more steps or continuously. The addition may be made separately or together with other components, such as emulsifiers or monomer emulsions. It is also possible to start the emulsion polymerization using a seed latex, for example with about 0.5 to about 15% by weight of the dispersion.

In addition to the emulsion polymerized vinyl acetate/ethylene copolymer, the copolymer dispersions used herein can additionally contain copolymers formed from C₁-C₁₈ esters of (meth) acrylic acids, C₁-C₁₈ esters of other ethylenically unsaturated mono-carboxylic acids, or C₁-C₁₈ diesters of ethylenically unsaturated di-carboxylic acids. Such additional copolymers can comprise, for example, from about 0.5 to about 20 parts by weight based on total copolymers in the copolymer dispersion and can include copolymers formed from ethyl acrylate, butyl acrylate (BuA), 2-ethylhexyl acrylate (2-EHA), dibutyl maleate, dioctyl maleate or combinations of these esters.

The molecular weight of the various copolymers in the copolymer dispersions herein can be adjusted by adding small amounts of one or more molecular weight regulator substances. These regulators, as they are known, are generally used in an amount of up to 2% by weight, based on the total co-monomers to be polymerized. As regulators, it is possible to use all of the substances known to the skilled artisan. Preference is given, for example, to organic thio compounds, silanes, allyl alcohols, and aldehydes.

The copolymer dispersions as prepared herein will generally have a viscosity which ranges from about 50 mPas to about 5000 mPas at 45-65% solids, more preferably from about 100 mPas to about 4000 mPas, most preferably 100 to 3000 mPas measured with a Brookfield viscometer at 25° C., 20 rpm, with appropriate spindle. Viscosity may be adjusted by the addition of thickeners and/or water to the copolymer dispersion. Suitable thickeners can include polyacrylates or polyurethanes, such as Borchigel L75® and Tafigel PUR 60®. Alternatively, the copolymer dispersion may be substantially free of thickeners.

Following polymerization, the solids content of the resulting aqueous copolymer dispersions can be adjusted to the level desired by the addition of water or by the removal of water by distillation. Generally, the desired level of polymeric solids content after polymerization is from about 40 weight percent to about 70 weight percent, more preferably from about 45 weight percent to about 65 weight percent, based on the total weight of the polymer dispersion.

The aqueous copolymer dispersions used to form the coating layer-forming compositions herein can be desirably low in Total Volatile Organic Compound (TVOC) content. A volatile organic compound is defined herein as a carbon containing compound that has a boiling point below 250° C. (according to the ISO 11890-2 method for polymer dispersions TVOC content determination) at atmospheric pressure. Compounds such as water and ammonia are excluded from VOCs.

The aqueous copolymer dispersions used herein will generally contain less than 0.3% TVOC by weight based on the total weight of the aqueous copolymer dispersion. Preferably the aqueous copolymer dispersion will contain less than 0.1% TVOC by weight based on the total weight of the aqueous copolymer dispersion.

Where appropriate, the vinyl acetate/ethylene copolymer dispersions used herein can also optionally comprise a wide variety of conventional additives which are typically used in the formulation of binders and/or adhesives. Such optional additives may be present in the copolymer dispersion from the beginning of or during polymerization, may be added to the dispersion post-polymerization or, such as in the case of fillers, may be used in connection with preparation of the aqueous coating compositions from the copolymer dispersions as hereinafter described.

Typical conventional optional additives for the copolymer dispersions herein can include, for example, film-forming assistants, such as white spirit, Texanol®, TxiB®, butyl glycol, butyl diglycol, butyl dipropylene glycol, and butyl tripropylene glycol; wetting agents, such as AMP 90®, TegoWet.280®, Fluowet PE®; defoamers, such as mineral oil defoamers or silicone defoamers; UV protectants, such as Tinuvin 1130®; agents for adjusting the pH; preservatives; plasticizers, such as dimethyl phthalate, diisobutyl phthalate, diisobutyl adipate, Coasol B, Plastilit 3060, and Triazetin; subsequently added stabilizing polymers, such as polyvinyl alcohol or cellulose ethers; thickeners, such as polyacrylates, such as Rohagit SD 15, Verdicker D4, and Rheosol EM 15; anti static agents, such as Elaktiv KH and Tallopol GNM, dispersing agents, such as sodium or ammonium salts of poly acrylic copolymer, such as Dispex A 40 and Dispex N 40 and styrene acrylic copolymers, such as Hydropalat 34, and other additives and auxiliaries of the kind typical for the formulation of binders and adhesives. The amounts of these additives used in the VAE copolymer dispersions herein can vary within wide ranges and can be selected according to the desired area of application.

### Aqueous Coating Compositions

The copolymer dispersions as hereinbefore described are combined with a particulate filler material, one or more other optional additives, such as the thickeners, anti-static agents and dispersing agents described above, and, where necessary, additional water to form aqueous coating compositions for the carpet products herein.

In one embodiment, the particulate filler material comprises calcium carbonate, especially relatively pure calcium carbonate (about 97% by weight), such as the limestone product Foamcarb 505W from the Alpha Calcit Group®. Alternatively, the filler may be selected from other commercially available particulate inorganic compounds and particulate plastic materials. Other filler examples include inorganic, e.g., mineral, fillers or pigments such as fly ash and ground glass and those known in the art, such as clay, kaolin, talc, barites, feldspar, titanium dioxide, calcium aluminum pigments, satin white, zinc oxide, barium sulphate, gypsum, silica, mica, and diatomaceous earth. Particulate plastic material such as synthetic polymer pigments, hollow polymer pigments and recycled carpet backing may also be employed, as can mixtures of any of the foregoing filler types. The preferred filler material is particulate calcium carbonate.

The particulate filler material can generally range in average particle size from about 200 nm to 1000 μm, more preferably from about 1 μm to 500 μm, most preferably from about 10 μm to 300 μm. In terms of ratios, the particulate filler material to dry copolymer ratio range may be from 1:1 to 10:1, and preferably, from 2:1 to 4:1.

Such coating compositions can contain in addition to the copolymer dispersions and filler materials hereinbefore described a variety of additional conventional additives in order to modify the properties thereof. Among these additives may be included thickeners, rheology modifiers, dispersants, flame retardants, colorants, biocides, anti-foaming agents, etc. These optional additives are largely the same as those hereinbefore described with respect to the copolymer dispersions herein.

### Carpet Products

The coating compositions hereinbefore described can then be applied to one or more flexible textile substrate(s), for example by back coating, to form the desired carpet products. Upon drying, the applied aqueous coating compositions then provide the coating layer(s) within the carpet products. The carpet product can comprise only one or more than one coating layer.

In general, the carpet products herein will always contain a binder coating layer to secure the carpet fibers to a primary backing substrate. The carpet products herein can then optionally also comprise a second or additional layer which may be an adhesive layer to secure a secondary backing substrate to the coated primary backing.

In one embodiment, the carpet product can comprise both a (pre-) coating and an adhesive layer which are formed from the same type of aqueous coating compositions as described herein. Alternatively, the carpet products herein can comprise both a coating layer as described herein and a different type of adhesive layer which may also be formed from the same type of compositions as the coating compositions herein or may be formed from a completely different conventional adhesive coating composition.

Suitable flexible substrates for use in the present carpet products can, for example, include nonwovens, wovens, unidirectional weaves, knitted fabrics and pile fabrics. Thus the carpet products herein can be conventional tufted carpet, or needle-punched carpet. Such carpet products can be prepared by applying and drying the emulsion copolymer-containing aqueous compositions using appropriate equipment designed for the purpose.

Pile carpet products comprise a primary backing with pile yarns extending from the primary backing substrate to form pile tufts. Pile or tufted carpet can be prepared by a) tufting or needling yarn into a woven or non-woven backing substrate; b) applying the aqueous carpet coating composition as described herein to the rear of the backing such that the yarn is embedded in the carpet coating composition; and c) drying the resultant carpet construction. In producing such tufted carpets, it is also possible, but not necessary, to apply a secondary backing to the primary backing either before or after drying of the carpet coating, depending upon the type of backing employed. For tufted carpets, the primary backing substrate can be non-woven polypropylene, polyethylene or polyester or woven jute, polypropylene or poly amide (synthetic and natural).

In preparing the carpet products herein, the aqueous composition is applied in a manner such that it penetrates the fibers of the carpet yarns to yield better adhesion, fiber bundle integrity, anti-fuzzing properties and suitable tuft-bind values. Suitable carpet performance properties can be achieved by applying an amount of the aqueous coating/binder composition ranging from about 100 g/m² to about 3000 g/m², more preferably from about 200 g/m² to about 2000 g/m², most preferably from about 400 g/m² to about 1500 g/m² (dry basis). The resultant carpet products exhibit excellent wet delamination properties.

The invention will now be more particularly described with reference to the following non-limiting Examples.

In the Examples, and the remainder of the present disclosure, the size of the solid particles within the copolymer dispersions is determined by laser diffraction using a Beckman Coulter LS 13320 analyzer. The laser diffraction principle is described in DIN ISO 13320. For the actual measurements used herein, between 1 to 10, typically 5 drops, of each sample were diluted in 5 ml of water. After thorough mixing, the diluted sample was transferred into the measurement chamber of the device. A further dilution of the sample was done automatically by the device in order to yield the optimum diffraction intensity for the method and device. Ultra-sonic treatment for 1 minute at 20 kHz, 70 Watt is used and, for calculating the result, a refractive index of real: 1.45 and imaginary: 0.0 is used.

The glass transition temperatures, Tg, reported in the Examples and used in the remainder of the present disclosure, were determined using a commercial differential scanning calorimeter Mettler DSC 820 at 10° K/min. For evaluation, the second heating curve was used and the DIN mid-point calculated.

### Copolymer Example 1—Dispersion Preparation

Into a pressure reactor fitted with an anchor stirrer (running at 180 rpm), a heating jacket, dosage pumps and having a volume of 30 liters, a water based solution of the following components is added:
5746.2 g Water (deionized)
971.3 g Polyvinyl alcohol solution (29%) having a degree of hydrolysis of 98-98.8 mol % and 4% solution viscosity of 3.5-4.5 mPa-s at 20° C.
971.3 g Polyvinyl alcohol solution (29%) having a degree of hydrolysis of 87-89 mol % and 4% solution viscosity of 4-5 mPa-s at 20° C.
301.8 g nonionic emulsifier-fatty alcohol polyglycol ether with 28 mol EO (70 wt % active content)
0.46 g Iron(III) chloride
1.55 g Brüggolit FF 6 (a sodium salt of a sulfinic acid derivative, obtained from L. Bruggemann KG) dissolved in 140.84 g of deionized water
4.51 g Defoamer
8.28 g Phosphoric Acid (to bring pH to 4.2).

The polyvinyl alcohol (29%) is dissolved in the deionized water at 90° C. for 2 hours. The reactor is purged with nitrogen to eliminate oxygen. Out of a total amount of 11267 g of vinyl acetate, 50% of the vinyl acetate is added to the water phase in the reactor. The ethylene valve is opened and the reactor is pressurized at ambient temperature (25° C.) until 61% (1718 g) of the total amount of ethylene (2817 g) is added. The ethylene valve is then closed again.

The reactor temperature is ramped up to 85° C. At 55° C. (the start temperature of the polymerization phase), the initiator feed, which is 26.62 g Brüggolit FF6 and 6.90 g NaHCO3 in 549 g of deionized water and 30.2 g tert-butylhydroperoxide (t-BHP) in 845.0 g of deionized water, is started and continued over 2-3 min until 100 g of each solution has been added. The temperature rises to 80° C. by exothermic reaction and at that point the initiator feed (oxidizer+reducer) is restarted so that the polymerization temperature is kept at 85° C. (switched to initiator control) and the cooling water temperature is fixed at 60° C. Additionally, when the reactor temperature reaches 80° C., the remaining 50% of the vinyl acetate monomer is added over 125 min and the ethylene supply is restarted and continued for 60 min (ethylene pressure is limited to 70 bar).

When the vinyl acetate monomer feed is completed, the initiator addition rate is increased to a maximum rate of 470 g/h (reducer solution) and of 700 g/h (oxidizer solution) and continued for additional 15 min after the end of the VAM addition. After the initiator feed is finished, the reaction temperature is maintained at 85° C. for about 40 min. The reactor is then cooled down to approximately 40° C. and the batch is released. A final redox treatment is made at this point by introducing Brüggolit FF 6 (5.2 g in 334 g of deionized water) and afterwards Trigonox AW 70 (3.2 g) and 7.5 g of 30% H2O2 in 370 g of deionized water. The product is stirred for 30 min before discharge.

The Example 1 VAE copolymer dispersion has the following characteristics (pphm=parts per hundred monomer):

| | |
|---|---|
| Ethylene content | 20 pphm |
| Solids content: | 59.7% |
| pH: | 5.57 |
| Viscosity Brookfield (25° C., Spindle 2, 20 rpm): | 800 mPas |
| Particle size distribution (Beckman Coulter LS 13320), | d_{w} = 930 nm |
| | d_{w}/dₙ = 1.7 |
| Residual vinyl acetate (ISO 11890-2): | <1000 ppm |

### Copolymer Example 2—Dispersion Preparation

Into a pressure reactor fitted with an anchor stirrer (running at 150 rpm), a heating jacket, dosage pumps and having a volume of 30 liters, a water based solution of the following components is added:
8837.6 g Water (deionized)
909.9 g Polyvinyl alcohol solution (15%) having a degree of hydrolysis of 98-98.8 mol % and 4% solution viscosity of 3.5-4.5 mPa-s at 20° C.
585 g nonionic emulsifier-fatty alcohol polyglycol ether with 28 mol EO (70 wt % active content)
231.1 g Sodium ethylene sulfonate (30%)
34.7 g Sodium acetate (anhydrous)
5.46 g Sodium Metabisulfite (Na₂S₂O₅)
0.031 g Mohr's Salt
1.65 g Defoaming Agent

The reactor is purged with nitrogen to eliminate oxygen. Out of a total amount of 12557 g of vinyl acetate, 10% of the vinyl acetate and 27.3 g of glycidyl methacrylate (GMA) is added to the water phase in the reactor. The ethylene valve is opened and the reactor is pressurized to about 20 bar at ambient temperature (at 25° C.) until 30% (364 g) of the total ethylene (1092 g) has been added The ethylene valve is then closed again.

The reactor temperature is ramped up to 65° C. At 50° C., the initiator feed, which is sodium peroxodisulfate (48.2 g in 1142 g of deionized water), is added (over 2-3 min at a rate of approx. 850 g/h) into the reactor. At 60° C., the second part of the vinyl acetate (90%) together with 246 g of glycidyl methacrylate is fed over 240 min into the reactor. At the same temperature (60° C.) the ethylene valve is opened again and the rest of the ethylene (70%) is fed into the reactor over approximately 10 min at maximum pressure of 45 bar. When the ethylene addition is finished (at temperature 65° C.) and the reaction temperature has reached the 65° C. and the water jacket temperature is set to ca. 55° C. Additionally at 60° C. the rest of the initiator solution is fed to the reactor with a feed rate of about 280 g/h for 250 min.

After the initiator feed is finished, the reaction temperature is maintained at 85° C. for 30 min. The reactor is then cooled down to approximately 40° C. and the batch is released. A final redox treatment is made at this point by introducing Brüggolit FF 6 (14 g in 205 g of deionized water) and afterwards Trigonox AW 70 (40 g in 205 g of deionized water). The product is stirred for 30 min before discharge.

The Example 2 VAE copolymer dispersion has the following characteristics:

| | |
|---|---|
| Ethylene content | 8 pphm |
| Solids content: | 55.5% |
| pH: | 4.9 |
| Viscosity Brookfield (25° C., Spindle 2, 20 rpm): | 250 mPas |
| Particle size distribution (Beckman Coulter LS 13320), d_{w}: | 220 nm |
| d_{w}/dₙ | 1.2 |
| Residual vinyl acetate (ISO 11890-2): | <500 ppm |

### Testing of Copolymer Dispersions of Examples 1 and 2

The copolymers of Examples 1 and 2 of the present invention were compared with two commercially available VAE copolymer dispersions, Celvolit 1328 and Vinamul 3925, and a commercially available styrene/butadiene copolymer dispersion, Litex T56R60, in a series of tests as described below designed to evaluate the utility of the dispersions in producing carpet products. Celvolit 1328 is a PVOH-stabilized VAE copolymer dispersion but with no PVOH having a degree of hydrolysis greater than 92 mol %. Vinamul 3925 is a mainly surfactant stabilized VAE copolymer dispersion with a PVOH content <6 pphm Litex T56R60 is an aqueous dispersion of a carboxylated styrene-butadiene copolymer.

### Filler Compatibility of Dispersions

The following materials were utilized to test the filler compatibility of the copolymer dispersions of Examples 1 and 2 and the commercially available materials according to the procedure detailed below.
Stirrer (IKA EUROSTAR power control-visc 6000)
Stirrer disc (5 cm diameter disc, operating at 1000-3000 rpm)
Filler CaCO₃ (AlphaCalcit Foamcarb 505W, 97.2% CaCO3, 1.2% MgCO₃, 0.2% Al₂O₃, 0.1% Fe₂O₃, 1.0% SiO₂, 0.2% humidity, particle size 0-74 μm)
Viscometer (Brookfield Spindle 4@20 rpm, 25° C.)

All dispersions are diluted to 50% solids prior to measurement. Dispersion in the amount of 200 g is weighed into a 600 ml metal beaker. In a first step, 180 g (=180 wt % filler load based on dry copolymer content) of filler are added over a time period of 5 minutes by the means of the stirrer into the dispersion. The speed of the stirrer is adjusted throughout the experiment in a way to keep the whole test carpet coating formulation in motion without introducing air (foam creation) into the test carpet coating formulation (approximately 1000-3000 rpm). After 5 minutes, the viscosity is measured with a Brookfield viscometer using spindle 4 with a speed of 20 rpm at 25° C. In a next step, 20 g of filler are added under stirring within 2 minutes and the viscosity is re-measured (Brookfield 4/20, 25° C.). This step is repeated a further 6 times until a filler load of 300 wt % based on copolymer (=80% solids) is reached. If a viscosity of >10000 mPas is measured during this process, the measurement is stopped. If the viscosity is still below 10000 mPas at a filler load of 300%, a final amount of 50 g filler is added within 5 minutes (=350% filler load/81.8% solids) under stirring and the viscosity is re-measured. The viscosity should be lower than 10000 mPas, preferably between 3000-8000 mPas, at a filler load of 300%.

A summary of the results of the filler compatibility test is presented below in Table 1.

TABLE 1

| | Filler load (viscosity development by adding filler)* | | | | | | | |
|---|---|---|---|---|---|---|---|---|
| | 180% | 200% | 220% | 240% | 260% | 280% | 300% | 350% |
| Dispersion | [mPas] | [mPas] | [mPas] | [mPas] | [mPas] | [mPas] | [mPas] | [mPas] |
| Example 1 | 950 | 1250 | 1670 | 2250 | 3190 | 3970 | 4830 | 8480 |
| Example 2 | 500 | 630 | 830 | 1040 | 1330 | 1670 | 2730 | 5900 |
| Celvolit 1328 | 1950 | 2500 | 3290 | 4160 | 5490 | 7460 | >10000 | |
| Vinamul 3925 | 2070 | 2330 | 2910 | 3520 | 4070 | 5140 | 6250 | >10000 |
| Litex T56R60 | 880 | 1020 | 1180 | 1400 | 1660 | 2000 | 2510 | 2670 |

*Good compatibility = viscosity at 300% filler load below 10000 mPas

It will be seen that the copolymer dispersions of Examples 1 and 2 show excellent filler compatibility particularly as compared to Celvolit 1328 and Vinamul 3925.

### Preparation of Test Carpet Coating Preparations

For each of the copolymer dispersions tested, the following materials were utilized to produce carpet coating preparations according to the method detailed below.
Dispersions with a solids content of 50%
Filler CaCO₃ (AlphaCalcit Foamcarb 505W, 97.2% CaCO₃, 1.2% MgCO₃, 0.2% Al₂O₃, 0.1% Fe₂O₃, 1.0% SiO₂, 0.2% humidity, particle size 0-74 μm,)
Thickener (Chimtex Thickener D4, poly acrylic acid neutralized, transparent liquid, viscosity <14000 mPas, solids ˜8%, pH ˜12)
Deionised water
Stirrer (IKA EUROSTAR power control-visc 6000)
Stirrer disc (5 cm diameter disc, 1000-3000 rpm)
Viscometer (Brookfield Spindle 4@20 rpm, 25° C.)

200 g of each dispersion (@50% solids) are weighed into a 500 ml graduated beaker and 12.8 g of water are subsequently added. The speed of the stirrer is adjusted throughout the process in order to keep the whole test carpet coating preparation in motion without introducing air (foam creation) into the test carpet coating preparation. Usually the stirrer speed will be between 1000-3000 rpm. 300 g of filler material (Foamcarb 505W) are slowly added to the dispersion to avoid the formation of lumps. After all the filler is added, the viscosity of the test carpet coating preparation is measured. The viscosity should be in a range to balance penetration into the base test carpet by ensuring good flowability, normally in a range of 3000-6000 mPas. If the viscosity is below 3000 mPas, a small amount of thickener is added, usually in a range of 0.1 to maximum 0.5% of the wet test carpet coating formulation. When thickener is used, the viscosity is re-measured. The resulting solid content of the test carpet coating preparation should be in a range of 78.0±0.2%.

The viscosities of the resultant carpet coating preparations are given in Table 2.

TABLE 2

| | Viscosity |
|---|---|
| | Carpet Coating |
| Dispersion | Formulation [mPas] |
| Example 1 | 4200 |
| Example 2 | 5700 |
| Celvolit 1328 | 3800 |
| Vinamul 3925 | 3500 |
| Litex T56R60 | 4200 |

### Foaming Properties of Carpet Coating Preparations

The following materials were utilized to test the foaming properties of the resultant carpet coating preparations according to the procedure detailed below.

### Materials

Lab balance (Mettler Toledo NewClassicMF MS6002S, ±0.01 g)
Kitchen mixer (Krups Handmixer 3MIX 5000)
2 Wire beaters (counter rotating, 4 symmetrically arranged S-shaped wires, maximum speed˜1800 rpm)
Pycnometer (Erichsen type 290, 100 ml)

The foaming test for carpet sample preparation is described herein. Test carpet coating formulations in the amount of 250 g are weighed into an 870 ml PP beaker. For foaming the test carpet coating formulation, a kitchen mixer at maximum speed is used (approximately 1800 rpm). At the beginning of the foaming, a stopwatch is started. Depending on the development of the foam generation, the mixer and the stopwatch are stopped and the achieved foam density is measured. If the test carpet coating formulation density is in the range of 950±50 g/l, the time needed (using a stopwatch) to reach this density is recorded. If the foam density is still too high, the test carpet coating formulation is foamed again at maximum speed (approximately 1800 rpm). The density is measured a second time and the sum of the first and second foamings of the carpet coating formulation is noted as the final foaming time [assuming the wanted foam density range (950±50 g/l) is reached]. If still too high or low, a new amount of test carpet coating formulation is used and the test repeated. If the foam density is already too low after the first foaming the test is repeated with a new amount of test carpet coating formulation. The time needed for achieving a foam density of 950±50 g/l should be below 300 s, preferably 30-200 s.

A summary of the results of the foaming tests of the carpet coating preparations is presented below in Table 3.

TABLE 3

| | Foaming time |
|---|---|
| | Carpet Coating |
| Dispersion | Formulation[s]* |
| Example 1 | 60 |
| Example 2 | 120 |
| Celvolit 1328 | >300 |
| Vinamul 3925 | 240 |
| Litex T56R60 | >300 |

*Good results = Time to reach a foam density of 950 ± 50 g/l (formulation) of <300 s

The formulation prepared with Celvolit 1328 dispersion was almost not foamable, and showed the worst performance concerning this property compared to all other samples. The formulations prepared with the dispersions of Examples 1 and 2 show improved foamability as compared to the formulations prepared with the Celvolit 1328, Vinamul 3925, and Litex T56R60. This results in a significant reduction in the time need to obtain a foam density of 950 g/l, without additional post additives to help with foaming. In particular, the carpet coating formulations of the invention at a CaCO₃ filler load of 300 wt % (based on solid copolymer) require less than 300 seconds, preferably less than 200 seconds, preferably less than 150 seconds, to achieve a foam density of 950±50 g/l.

### Drying Properties of Carpet Coating Preparations

The following materials were utilized to test the drying properties of the carpet coating preparations according to the procedure detailed below.
AA-GWR Water Retention Meter (Kaltec Scientific)
Syringe 20 ml (one way/BD Plastipak)
Filter PCTE (5.0 μm; Φ47 mm/Kaltec Scientific)
Blotting paper (chromatography 17; 57×57 mm/Kaltec Scientific)

The water retention test is a method used in the paper industry to ensure that the paper coating retains water without excessive softening of the paper. For carpet coating preparations, a high water release rate is wanted to speed up the drying process. To test the capability to retain/release water in the test carpet coating preparations, the following procedure was followed. First the blotting paper is weighed. The PCTE filter is then placed on top of the blotting paper and both are put onto a rubber mat. Finally, the test cylinder (area 1/1500 m²) is applied to the PCTE filter. Test formulation in the amount of 15 ml is drawn into the syringe, avoiding the formation of air in the enclosure which is then adjusted to 10 ml volume. The content of the syringe is transferred into the test cylinder and set in the testing device; the measurement is started after 15 seconds. For the measurement, a pressure of 0.5 bar is applied for 90 seconds on the sample. The blotting paper is weighed immediately to evaluate the water transferred through the filter onto the blotting paper. The result is the difference in weight of the blotting paper before and after measurement, adjusted by a multiplication factor to get a result in g/m² of water transferred through the filter. High results show a good capability of the test carpet formulation to release water. The target is to achieve a result higher than 150 g/m², preferably higher 170 g/m².

A summary of the results of the water retention test is presented below in Table 4.

TABLE 4

| | Water retention* |
|---|---|
| Dispersion | [g/m²] |
| Example 1 (inventive) | 236 |
| Example 2 (inventive) | 235 |
| Celvolit 1328 | 146 |
| Vinamul 3925 | 88 |
| Litex T56R60 | 110 |

As shown in Table 4, the carpet preparations using the copolymer dispersions of Examples 1 and 2 have high water retention values, which means that water is easily released from the preparations. This water retention value is higher than that for the preparations containing Celvolit 1328, Vinamul 3925 and Litex T56R60.

### Preparation of Test Carpet Samples

For each of the carpet coating preparations, the following materials were utilized to produce test carpet samples according to the procedure detailed below.
Test carpet coating preparation as described above
Unbacked carpet material (Loop pile, polypropylene (PP), tuft density ˜176000 tufts/m², tufting base PP web ˜87 g/m², base weight ˜410 g/m², 30×25 cm)
Secondary backing (ActionBac, PP scrim, ˜57 g/m², 3×4 mm with 4 mm side in machine direction, 30×25 cm)
Kitchen mixer (Krups Handmixer 3MIX 5000)
2 Wire beaters (counter rotating, 4 symmetrical arranged s-shaped wires, maximum speed ˜1800 rpm)
Pycnometer (Erichsen type 290, 100 ml)
Circulating air oven (Memmert UFE 550)

Carpet coating preparations in the amount of 250 g are weighed into an 870 ml PP beaker and are foamed at the maximum speed of the kitchen mixer (˜1800 rpm) until a foam density of 950±50 g/l is reached. Foamed test carpet formulations in the amount of 80 g (1000 g/m² add on) are weighed onto the backside of the raw carpet material. The test carpet formulation is evenly distributed by the means of a bench scraper onto an area of 25×25 cm of the unbacked carpet material leaving 5 cm in machine direction uncoated. The secondary backing is laid into the wet test carpet formulation which has been applied to raw carpet, gently working it in using a card to position the scrim on the test carpet formulation. The test carpet is dried for 15 min at 130° C. in a circulating air oven. The final test carpet samples are stored for approximately 24 h at 50% humidity and 23° C. prior to measurement of their wet and dry delamination strength.

### Delamination Test Method

The dry and wet delamination strength of the secondary backing of the coated test carpet samples described above were measured according to ISO 118657 using a LF Plus testing device provided by Lloyd Instruments. In the case of the wet delamination strength, the test carpet samples are immersed in water for 10 seconds and allowed to swell for an additional 2 hours prior to measurement.

All measurements take place in a climate-controlled room at 23° C. and 50% humidity using the following test conditions:
Preload: 0.5 N
Preload speed: 20 mm/min
Peel length: 10 cm
Speed: 100 mm/min

Initially, 5 cm of the backing scrim is peeled from the test carpet back and the ends are covered with adhesive tape to hold scrim fibres together and to prevent the testing device clamps from getting dirty. The test carpet sample is clamped to the testing device so that the sample is under tension and is not hanging loosely (distance between clamps: about 8 cm). The test is then started. For calculation purposes, the first and the last 2.5 cm are not taken into consideration. The resulting calculation length of 15 cm is separated into 5 equal areas. In each of these areas the maximum peel result is determined. The average of these five values represents the average maximum delamination strength for the tested sample. The results are shown in Table 5

TABLE 5

| | dry* | wet** |
|---|---|---|
| Dispersion | [N/5 cm] | [N/5 cm] |
| Example 1 (inventive) | 30 | 21 |
| Example 2 (inventive) | 31 | 13 |
| Celvolit 1328 | 37 | 11 |
| Vinamul 3925 | 38 | 8 |
| Litex T56R60 | 35 | 25 |

*Good = >30 N/5 cm
**Good = >10 N/cm

As shown in Table 5, the carpet sample produced using the copolymer dispersion of Example 1 showed a relatively low dry delamination strength (lower than Vinamul 3925, Litex T56R60 and Celvolit 1328), but good wet delamination strength. The wet delamination results are better than Vinamul 3925 and the Celvolit 1328 samples, and almost within the value range of Litex T56R60.

The carpet sample produced using the copolymer dispersion of Example 2 again shows lower dry delamination results than the prior art dispersions. Wet results are improved compared to the Vinamul 3925 and Celvolit 1328 samples, but are lower than Example 1 and Litex T56R60.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

1. An aqueous carpet coating composition comprising: (A) at least one particulate filler material; and (B) a stabilized copolymer dispersion comprising:
(a) a copolymer formed by emulsion polymerization of a monomer mixture comprising a vinyl ester of an alkanoic acid having from 1 to 18 carbon atoms and from 1 to 25 pphm of ethylene, wherein the copolymer comprises particles having a weight average particle size, d_{w}, of at least 200 nm as determined by laser diffraction;
(b) water; and
(c) a stabilizing system comprising (i) from 1 to 4 pphm of an emulsifier component consisting of at least one non-ionic surfactant and (ii) 0.5 to 4 pphm of at least one first polyvinyl alcohol component having a degree of hydrolysis greater than 92 mol %.

2. The composition of claim 1, wherein the vinyl ester of an alkanoic acid having from 1 to 18 carbon atoms comprises vinyl acetate.

3. The composition of claim 1, wherein the copolymer comprises from 6 to 20 pphm of ethylene.

4. The composition of claim 1, wherein the copolymer comprises from 6 to 14 pphm of ethylene.

5. The composition of claim 1, wherein the copolymer has a weight average particle size, d_{w}, from 200 to 1500 nm as determined by laser diffraction.

6. The composition of claim 1, wherein the first polyvinyl alcohol component has a Höppler viscosity, as measured at 20° C. on a 4% by weight concentration aqueous solution, of less than 10 mPa-s.

7. The composition of claim 1, wherein the stabilizing system further comprises (iii) up to 8 pphm of at least one second polyvinyl alcohol component having a degree of hydrolysis greater than 80 mol % and less than 90 mol %.

8. The composition of claim 7, wherein the at least second polyvinyl alcohol component has a Höppler viscosity, as measured at 20° C. and a 4% by weight concentration aqueous solution, of 2 to 60 mPa-s.

9. The composition of claim 1, wherein the weight ratio of particulate filler material to dry copolymer is from 1:1 to 10:1.

10. The composition of claim 1 having a water retention value of greater than 150 g/m², preferably greater than 170 g/m².

11. The composition of claim 1, wherein the at least one particulate filler material is a filler consisting essentially of calcium carbonate having a particle size of 90 μm or less.

12. The composition of claim 1 and requiring less than 300 s to achieve a foam density of 950±50 g/l.

13. A carpet product comprising at least one flexible substrate and at least one coating or adhesive layer associated with said at least one flexible substrate, said coating or adhesive layer being formed from an aqueous coating composition comprising: (A) at least one particulate filler material; and (B) a stabilized copolymer dispersion comprising:
(a) a copolymer formed by emulsion polymerization of a monomer mixture comprising a vinyl ester of an alkanoic acid having from 1 to 18 carbon atoms and from 1 to 25 pphm of ethylene, wherein the copolymer has a weight average particle size, d_{w}, in excess of 200 nm as determined by laser diffraction;
(b) water; and
(c) a stabilizing system comprising (i) from 1 to 4 pphm of an emulsifier component consisting of at least one non-ionic surfactant and (ii) 0.5 to 4 pphm of at least one first polyvinyl alcohol component having a degree of hydrolysis greater than 92 mol %.

14. The carpet product of claim 13, wherein the vinyl ester of an alkanoic acid having from 1 to 18 carbon atoms comprises vinyl acetate.

15. The carpet product of claim 13, wherein the copolymer comprises from 6 to 20 pphm of ethylene.

16. The carpet product of claim 13, wherein the copolymer comprises from 6 to 14 pphm of ethylene.

17. The carpet product of claim 13, wherein the copolymer has a weight average particle size, d_{w}, from 200 to 1500 nm as determined laser diffraction.

18. The carpet product of claim 13, wherein the first polyvinyl alcohol component has a Höppler viscosity, as measured at 20° C. on a 4% by weight concentration aqueous solution, of less than 10 mPa-s.

19. The carpet product of claim 13, wherein the stabilizing system further comprises (iii) up to 8 pphm of at least one second polyvinyl alcohol component having a degree of hydrolysis greater than 80 mol % and less than 90 mol %.

20. The carpet product of claim 19, wherein the second polyvinyl alcohol component has a Höppler viscosity, as measured at 20° C. and a 4% by weight concentration aqueous solution, of 2 to 60 mPa-s.

21. The carpet product of claim 13, wherein the weight ratio of particulate filler material to dry copolymer is from 1:1 to 10:1.

22. The carpet product of claim 13, wherein the at least one particulate filler material is a filler consisting essentially of calcium carbonate having a particle size of 90 μm or less.

23. The carpet product of claim 13, having a wet delamination strength of at least 11 N/5 cm, and preferably at least 13 N/5 cm.
